(19) United States
(12) Patent Application Publication
(10) Pub. No.: US 2010/0313028 A1
(43) Pub. Date: Dec. 9, 2010

(54) Electronic Signature Method and Electronic Signature Tool

(75) Inventor: Dongsheng Li, Beijing (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: TENDYRON CORPORATION, Beijing (CN)

(21) Appl. No.: 12/856,549

(22) Filed: Aug. 13, 2010

Related U.S. Application Data
(63) Continuation of application No. PCT/CN2007/000976, filed on Mar. 27, 2007.

(30) Foreign Application Priority Data
Feb. 8, 2007 (CN) 200710063745.2

(51) Int. Cl. H04L 9/32

(52) U.S. Cl. 713/173; 726/16

(57) ABSTRACT

The present invention provides an electronic signature method and an electronic signature tool. The method includes: outputting verification prompt information; receiving verification confirmation information inputted by a user; checking whether the verification confirmation information matches the verification prompt information, and performing the predetermined electronic signature operation if the verification confirmation information matches the verification prompt information. Through the electronic signature method and the electronic signature tool of the present invention, an attack of other users on the network can be prevented, secure transactions are realized. The method and the tool are used conveniently and can be popularized easily.

### FIELD OF THE INVENTION

The present invention relates to the field of electronic technology applications, and more particularly, to an electronic signature method and an electronic signature tool.

### BACKGROUND OF THE INVENTION

Because an electronic signature tool (such as USBKEY) can perform encryption, signature and authentication for data, many users would use the electronic signature tool currently when transmitting various data over the Internet, e.g. when conducting transactions at an E-bank, so as to increase security of data transmission over the Internet.

However, because security of the Internet is relatively poor, computers of the users may be kidnapped by hacker software such as Trojan horse. As a result, even if the users have performed the signature, encryption or authentication for the transmitted data by using the electronic signature tool, an attacker (i.e. hacker) still can directly operate the electronic signature tool through remote control and thereby counterfeiting a transaction, which causes a huge loss to the users.

The existing online transactions generally adopt a pattern identification code manner to prevent an automatic attack of the attacker. Specifically, an online transaction center randomly selects a group of numbers or letters, displays a picture containing the selected group of data to a user through a computer connected to the Internet, prompts the user to input the numbers or letters displayed, determines whether the numbers or letters inputted by the user are consistent with the randomly-selected numbers or letters through comparison, and performs following operations only when the numbers or letters inputted by the user are consistent with the randomly-selected numbers or letters.

However, because the number of the randomly-selected numbers or letters is limited, the attacker may decipher the picture sent by the online transaction center by using exhaust algorithm for comparing pictures, or by directly intercepting the picture. Therefore, the transaction security of the users is threatened.

### SUMMARY OF THE INVENTION

In view of the above, an embodiment of the present invention provides an electronic signature method, which can prevent an attack of other users on the network and can realize security transactions.

An embodiment of the present invention further provides an electronic signature tool, which can prevent an attack of other users on the network, can realize security transactions, and can be used easily and conveniently and can facilitate popularization.

According to an embodiment of the present invention, the electronic signature method includes:
outputting verification prompt information before performing a predetermined electronic signature operation;
receiving verification confirmation information inputted by a user;
checking whether the verification confirmation information matches the verification prompt information, and performing the predetermined electronic signature operation if the verification confirmation information matches the verification prompt information.

According to another embodiment of the present invention, the electronic signature tool includes:
a prompt information generating module, adapted to generate verification prompt information;
an information prompt module, adapted to output the verification prompt information to a user;
a data receiving module, adapted to receive verification confirmation information inputted by the user; and
a predetermined operation processing module, adapted to check whether the verification confirmation information matches the verification prompt information, perform a predetermined electronic signature operation if the verification confirmation information matches the verification prompt information.

As can be seen from the foregoing electronic signature method and electronic signature tool, the electronic signature tool first outputs the verification prompt information to the user, then receives the verification confirmation information inputted by the user, and determines whether to perform the predetermined electronic signature operation according to the verification confirmation information and the verification prompt information. Therefore, the attack of other users on the network can be prevented and the security transactions can be realized.

### BRIEF DESCRIPTION OF THE DRAWINGS

FIG. 1 is a flowchart illustrating an electronic signature method according to an embodiment of the present invention.

FIG. 2 is a schematic diagram illustrating a structure of an electronic signature tool according to an embodiment of the present invention.

### DETAILED DESCRIPTION OF THE INVENTION

In order to make the purpose, solutions and merit more clear, the present invention will be described hereinafter in detail with reference to accompanying drawings and embodiments.

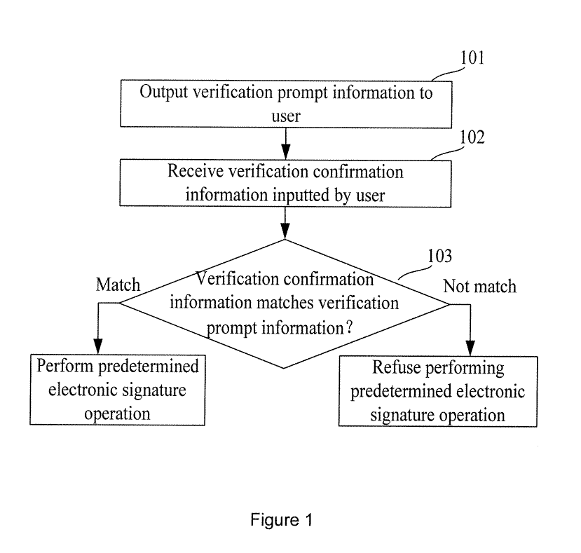

An embodiment of the present invention provides an electronic signature method. As shown in FIG. 1, the electronic signature method mainly includes:

Step 101: An electronic signature tool outputs verification prompt information to a user when the electronic signature tool is required to perform a predetermined electronic signature operation.

In this embodiment, the predetermined electronic signature operation may include, but is not limited to, any type or several types of the following signature operations: a signature calculation, an encryption calculation, a decryption calculation, signature check, key pair generation, public key output and key import.

In this step, the verification prompt information may be generated by the electronic signature tool; or, may be an authentication code, such as a graphic authentication code, transmitted by an online transaction center. Generally, the authentication code transmitted by the online transaction center to the electronic signature tool is encrypted. In this case, the electronic signature tool first decrypts the received authentication code and then outputs the decrypted authentication code as the verification prompt information to the user.

In this step, the electronic signature tool may output the verification prompt information in many manners, for example, may play the verification prompt information to the user through a voice prompt module in the electronic signature tool, or may display the verification prompt information to the user through a display apparatus in the electronic signature tool, or may simultaneously play and display the verification prompt information to the user through the voice prompt module and the display apparatus in the electronic signature tool.

Step 102: The electronic signature tool receives verification confirmation information inputted by the user.

In this step, the user may input the verification confirmation information in many manners. For example, the user may input the verification confirmation information through a keyboard or mouse of a computer connected with the electronic signature tool and then the computer transmits the verification confirmation information to the electronic signature tool via an interface connecting the electronic signature tool. For another example, the electronic signature tool may be configured with an input apparatus, and the user may input the verification confirmation information through the input apparatus of the electronic signature tool directly. For yet another example, the user may input the verification confirmation information through cooperation between the input apparatus in the electronic signature tool and the keyboard and mouse of the computer connected with the electronic signature tool.

Step 103: The electronic signature tool checks whether the verification confirmation information inputted by the user matches the verification prompt information. If they match, the electronic signature tool performs the predetermined electronic signature operation; otherwise, the electronic signature tool refuses performing the predetermined electronic signature operation.

In this step, checking whether the verification confirmation information inputted by the user matches the verification prompt information may be: checking whether the verification confirmation information is the same as the verification prompt information, or checking whether the verification confirmation information and the verification prompt information comply with a predetermined matching condition.

Specifically, the predetermined matching condition may include: an encryption/decryption rule with which the verification confirmation information and the verification prompt information comply; or, an algorithm with which the verification confirmation information and the verification prompt information comply, for example, a certain operation (e.g. square, reverse order, multiples or a certain difference) with which the verification confirmation information and the verification prompt information comply.

As can be seen, the electronic signature method in this embodiment is applicable to the electronic signature tool with an information prompt function (e.g. a voice playing function and/or a display function). When the user adopts the electronic signature tool to perform some predetermined electronic signature operations, the electronic signature tool takes a group of data (including numbers and/or letters) generated randomly by itself or take the authentication code received from the online transaction center as the verification prompt information, and prompts the user for the group of data or the authentication code through the information prompt function of the electronic signature tool. After hearing or seeing the prompt of the electronic signature tool, the user inputs the verification confirmation information through the computer connected with the electronic signature tool or through the input apparatus of the electronic signature tool. Afterward, the electronic signature tool checks whether the verification confirmation information matches the verification prompt information, and performs the subsequent predetermined electronic signature operation only when they match. Thereby, possibility and feasibility of any outside attacks can be eliminated.

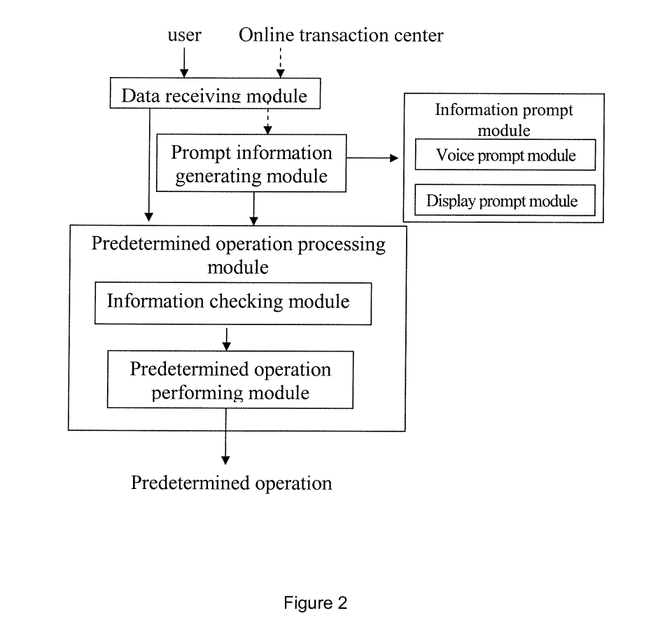

An embodiment of the present invention further provides an electronic signature tool. As shown in FIG. 2, the electronic signature tool mainly includes: a prompt information generating module, an information prompt module, a data receiving module and a predetermined operation processing module.

The prompt information generating module is adapted to generate verification prompt information.

The information prompt module is adapted to output the verification prompt information generated by the prompt information generating module to a user.

The data receiving module is adapted to receive verification confirmation information inputted by the user.

The predetermined operation processing module is adapted to check whether the verification confirmation information from the data receiving module matches the verification prompt information generated by the prompt information generating module, perform a predetermined electronic signature operation if they match, and refuse performing the predetermined electronic signature operation if they do not match. The predetermined operation processing module may include an information checking sub-module and a predetermined operation performing sub-module, adapted to perform the above information matching function and the electronic signature function respectively.

In this embodiment, the prompt information generating module may randomly generate the verification prompt information, or may generate the verification prompt information according to an authentication code transmitted by an online transaction center. If the authentication code transmitted by the online transaction center is encrypted, the prompt information generating module first decrypts the received authentication code and then generates the verification prompt information. In the case of generating the verification prompt information according to the authentication code transmitted by the online transaction center, the data receiving module is further adapted to receive the authentication code transmitted by the online transaction center.

As described above, the user may input the verification confirmation information through a keyboard or mouse of a computer connected with the electronic signature tool, or the user may input the verification confirmation information through the electronic signature tool directly. In the latter case, the electronic signature tool may further be configured with an input apparatus, such as a keyboard or a multi-directional operation handle.

In addition, the information prompt module may output the verification prompt information to the user in various manners. For example, the information prompt module may include a voice prompt module, adapted to output the verification prompt information to the user by way of voice prompting. For another example, the information prompt module may include a display apparatus, adapted to output the verification prompt information to the user by way of screen displaying. For yet another example, the information prompt module may include both the voice prompt module and the display apparatus, adapted to output the verification prompt information to the user by way of voice prompting and screen displaying at the same time.

As can be seen, through the electronic signature tool in this embodiment, the predetermined electronic signature operation is performed only when the verification confirmation information inputted by the user matches the verification prompt information outputted by the electronic signature tool. Therefore, the possibility that the electronic signature tool is kidnapped and controlled remotely can be completely eliminated. Meanwhile, a venture of being deciphered by the outside can also be eliminated and thus the security of electronic transactions of a user is increased greatly.

In addition, the electronic signature tool in this embodiment may be obtained by making a small change to conventional electronic signature tools and need not meet special requirements. Therefore, the electronic signature tool in this embodiment has advantages, such as convenient implementation, lower costs, strong universality and practicability, etc, and can be popularized and used conveniently.

The foregoing is only embodiments of the present invention. The protection scope of the present invention, however, is not limited to the above description. Any change or substitution, easily occurring to those skilled in the art, should be covered by the protection scope of the present invention.

1. An electronic signature method, comprising:
outputting verification prompt information before performing a predetermined electronic signature operation;
receiving verification confirmation information inputted by a user;
checking whether the verification confirmation information matches the verification prompt information, and performing the predetermined electronic signature operation if the verification confirmation information matches the verification prompt information.

2. The method of claim 1, wherein outputting the verification prompt information comprises:
randomly generating a group of data as the verification prompt information and outputting the verification prompt information.

3. The method of claim 1, wherein outputting the verification prompt information comprises:
decrypting an authentication code encrypted and transmitted by an online transaction center, taking the authentication code decrypted as the verification prompt information, and outputting the verification prompt information.

4. The method of claim 1, wherein outputting the verification prompt information comprises:
outputting the verification prompt information by way of voice prompting.

5. The method of claim 1, wherein outputting the verification prompt information comprises:
outputting the verification prompt information by way of screen displaying.

6. The method of claim 4, wherein outputting the verification prompt information comprises:
outputting the verification prompt information by way of screen displaying.

7. The method of claim 1, wherein checking whether the verification confirmation information matches the verification prompt information comprises:
checking whether the verification confirmation information is the same as the verification prompt information.

8. The method of claim 1, wherein checking whether the verification confirmation information matches the verification prompt information comprises:
checking whether the verification confirmation information and the verification prompt information comply with a predetermined matching condition.

9. The method of claim 8, wherein the predetermined matching condition comprises:
an encryption/decryption rule with which the verification confirmation information and the verification prompt information comply; or,
an algorithm with which the verification confirmation information and the verification prompt information comply.

10. The method of claim 1, wherein the predetermined electronic signature operation comprises at least one of: a signature calculation, an encryption calculation, a decryption calculation, signature check, key pair generation, public key output and key import.

11. The method of claim 1, further comprising:
refusing performing the predetermined electronic signature operation if the verification confirmation information does not match the verification prompt information.

12. An electronic signature tool, comprising:
a prompt information generating module, adapted to generate verification prompt information;
an information prompt module, adapted to output the verification prompt information to a user;
a data receiving module, adapted to receive verification confirmation information inputted by the user; and
a predetermined operation processing module, adapted to check whether the verification confirmation information matches the verification prompt information, perform a predetermined electronic signature operation if the verification confirmation information matches the verification prompt information.

13. The tool of claim 12, wherein the data receiving module is further adapted to receive an authentication code encrypted and transmitted by an online transaction center, and transmit the authentication code to the prompt information generating module;
the prompt information generating module is adapted to decrypt the authentication code and take the authentication code decrypted as the verification prompt information.

14. The tool of claim 12, wherein the data receiving module comprises an input apparatus through which the user inputs the verification confirmation information.

15. The tool of claim 12, wherein the information prompt module comprises:
a voice prompt module, adapted to output the verification prompt information by way of voice prompting.

16. The tool of claim 12, wherein the information prompt module comprises:
a display apparatus, adapted to output the verification prompt information to the user by way of screen displaying.

17. The tool of claim 14, wherein the information prompt module comprises:
a display apparatus, adapted to output the verification prompt information to the user by way of screen displaying.

18. The tool of claim 12, wherein the predetermined operation processing module comprises:
an information checking sub-module, adapted to check whether the verification confirmation information matches the verification prompt information; and
a predetermined operation performing sub-module, adapted to perform the predetermined electronic signature operation if the verification confirmation information matches the verification prompt information; refuse performing the predetermined electronic signature operation if the verification confirmation information does not match the verification prompt information.
